(19) United States
(12) Patent Application Publication
(10) Pub. No.: US 2006/0017389 A1
(43) Pub. Date: Jan. 26, 2006

(54) Lamp dimming control device using temperature compensation

(76) Inventor: Shi Youl Noh, Seoul (KR)

Correspondence Address: Joseph Hyosuk Kim, Ph.D.;JHK Law, P.O. Box 1078, La Canada, CA, 91012-1078, US

(21) Appl. No.: 10/889,691

(22) Filed: Jul. 12, 2004

(51) Int. Cl. H01J 13/32; H01J 7/24

(52) U.S. Cl. 315/112

(57) ABSTRACT

The present invention discloses a lamp dimming control device using temperature compensation. The lamp dimming control device includes: a temperature sensor 10 for sensing the ambient temperature of the lamp; a controller 20 for detecting a temperature value of the temperature sensor, comparing the detected temperature value with a minimum power value depending on a temperature, previously set by a program, to decide a minimum illumination intensity, and outputting a dimming control signal with the minimum illumination intensity; a decoder 30 connected with the controller through a communication line, installed in an illuminating device including the lamp, for decoding the output value of the controller to output a signal for controlling the lamp; and a ballast 40 for controlling turning on and brightness of the lamp in response to the output signal of the decoder 30.

### BACKGROUND OF THE INVENTION

1. Field of the Invention

The present invention relates to a lamp dimming control device, and more particularly, to a lamp dimming control device using temperature compensation, which detects a temperature using a temperature sensor and automatically controls a dimming range and an optimum illumination intensity in response to the detected temperature to thereby enable a normal operation of a lamp and extend the expected life span of the lamp.

2. Background of the Related Art

A conventional lamp ballast is serially connected to a fluorescent lamp with a choke coil formed in such a manner that a coil is wound on an iron core so as to prevent current from increasing. This consumes a high power when the lamp is initially turned on. Accordingly, electronic ballasts of various types using a semiconductor have been recently developed.

The electronic ballasts remove noises such as surge and impulse voltages, introduced from an input power supply during AC/DC or DC/HF conversion, using a filter. However, over-current caused by a voltage increase when a lamp is initially turned on abruptly increases a temperature to destroy the semiconductor of the electronic ballast. Furthermore, a lamp filament is rapidly blackened to shorten the life span of the lamp, which causes a user to suffer from an inconvenience of frequently replacing a used lamp with a new one. Moreover, it is difficult to control the brightness of the lamp to thereby result in a increase in power consumption.

As a tube with a smaller diameter is frequently used for a lamp, the lamp is affected by the ambient temperature. In the case where the ambient temperature of the lamp is decreased to a very low temperature in the wintertime, the lamp is turned on only when an initiating voltage is very high. Accordingly, the life span of the lamp is remarkably reduced due to over-current. Furthermore, stabilized brightness control at the initial stage becomes difficult.

### SUMMARY OF THE INVENTION

Accordingly, the presenting invention has been made to resolve the above problems occurring in the prior art, and it is an object of the present invention is to provide a lamp dimming control device using temperature compensation, which automatically controls a dimming range and an optimum illumination intensity in response to the ambient temperature using a temperature sensor, to thereby prevent the life span of a lamp from being shortened due to dimming at a low temperature.

Another object of the present invention is to provide a lamp dimming control device using temperature compensation, which automatically controls an output illumination intensity on the basis of a temperature detection value and controls dimming on the basis of an illumination intensity a user sets in response to an increase in the temperature detection value to thereby minimize an influence of the ambient temperature on the lamp.

In an aspect of the present invention, there is provided a lamp dimming control device wherein a controller generates a control signal depending on brightness controlled by a user and a ballast controls dimming of a lamp in response to the control signal, to thereby control turning on and brightness of the lamp, including: a temperature sensor for sensing the ambient temperature of the lamp; a controller for detecting a temperature value of the temperature sensor, comparing the detected temperature value with a minimum power value depending on a temperature, previously set by a program, to decide a minimum illumination intensity, and outputting a dimming control signal with the minimum illumination intensity; a decoder connected with the controller through a communication line, installed in an illuminating device including the lamp, for decoding the output value of the controller to output a signal for controlling the lamp; and a ballast for controlling turning on and brightness of the lamp in response to the output signal of the decoder.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram of a lamp dimming control device using temperature compensation according to an embodiment of the present invention;

FIG. 2 is block diagram of the controller of the lamp dimming control device using temperature compensation according to an embodiment of the present invention;

FIG. 3 is a block diagram of the microcomputer of the lamp dimming control device using temperature compensation according to an embodiment of the present invention;

FIG. 4 is a graph showing the relationship between a ratio of the maximum illumination intensity to the minimum illumination intensity and a temperature;

FIG. 5 is a block diagram of a lamp dimming control device using temperature compensation according to another embodiment of the present invention; and

FIG. 6 is a block diagram of the decoder of the lamp control device using temperature compensation according to another embodiment of the present invention.

### DETAILED DESCRIPTION OF THE PREFERRED EMBODIMENT

Reference will now be made in detail to the preferred embodiments of the present invention, examples of which are illustrated in the accompanying drawings.

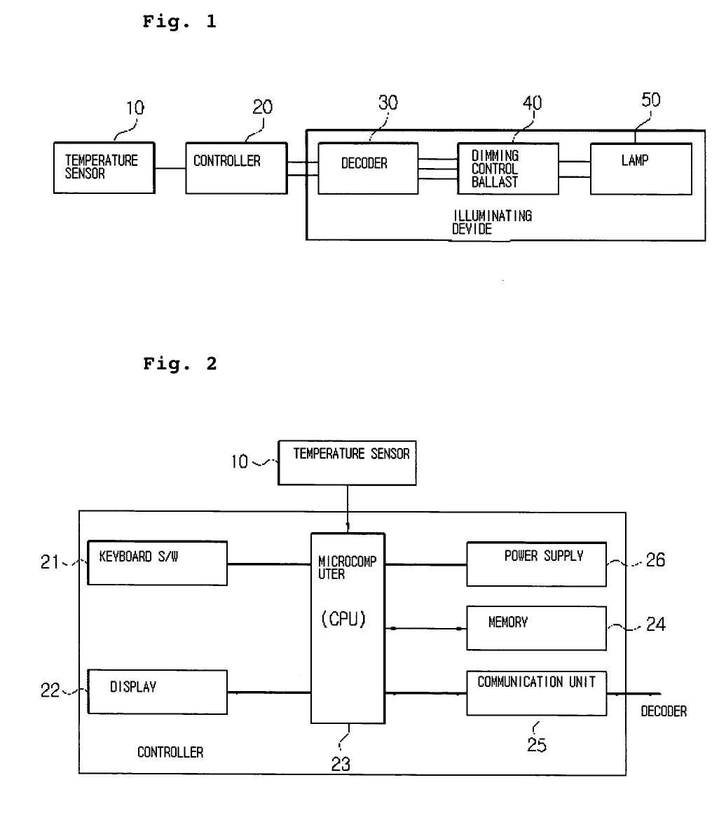

FIG. 1 is a block diagram of a lamp dimming control device using temperature compensation according to an embodiment of the present invention.

Referring to FIG. 1, the lamp dimming control device using temperature compensation according to an embodiment of the present invention includes a temperature sensor 10 for sensing the ambient temperature of a lamp 50, and a controller 20 that detects a temperature value of the temperature sensor 10, compares the temperature value with a minimum output value depending on a temperature, which is previously set by a program, to decide a minimum illumination intensity and outputs a dimming control signal with the minimum illumination intensity. The lamp dimming control device further includes a decoder 30 that is connected to the controller 20 using a communication line and installed in an illuminating device including the lamp to decode the output value of the controller 20, and a ballast 40 for controlling turning on of the lamp 50 with the minimum illumination intensity in response to the signal decoded by the decoder 30.

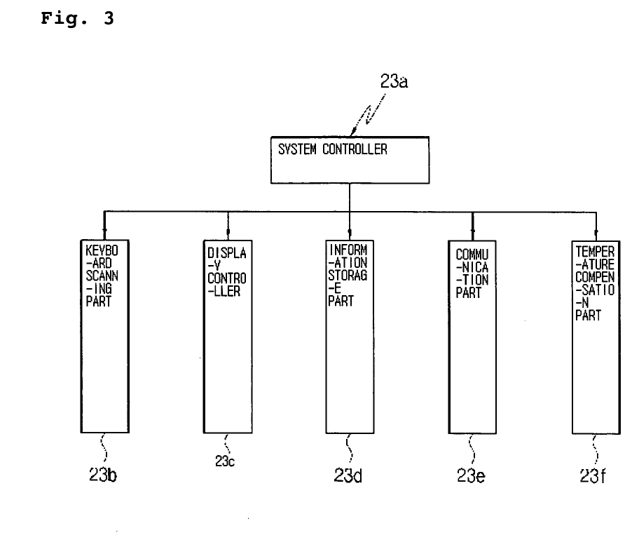

FIG. 2 is block diagram of the controller of the lamp dimming control device using temperature compensation. Referring to FIG. 2, the controller includes a keyboard 21 through which a user inputs signals for controlling on/off and brightness of the lamp, a display unit 22 for displaying a user's input state and an operation state using an LED, and a microcomputer 23 that receives signals from the temperature sensor 10 and the keyboard 21 to control the display unit 22 and controls turning on and brightness of the lamp according to temperature detection and compensation. The controller further includes a memory 24 for storing a program for the control operation of the microcomputer and output data about a minimum illumination intensity depending on a temperature, a communication unit 25 that outputs a lamp control signal according to the control of the microcomputer 23 to the decoder 30 installed in the illuminating device through a communication line, and a power supply 26 for providing an operation power to the controller 20.

FIG. 3 is an internal program functional block diagram of the microcomputer of the lamp dimming control device. As shown in FIG. 3, the microcomputer includes a system controller 23a for controlling on/off and dimming of the lamp, a keyboard scanning part 23b for scanning the keyboard 21 to receive a key signal, and a display controller 23c for controlling the display unit 22. The microcomputer further includes an information storage part 23d that stores information in the memory 24 and reads information from the memory 24, a communication part 23e that transmits the lamp control signal of the microcomputer 23 to the decoder 30, and a temperature compensation part 23f that carries out temperature compensation to control a minimum output value for being compared with a temperature detection value of the temperature sensor 10 and a minimum illumination intensity based on the minimum output value. These components are previously stored in the microcomputer 23 as internal programs of the microcomputer 23. These internal programs are executed by the microcomputer 23.

The present invention constructed as above installs the temperature sensor 10 such that the temperature sensor 10 can sense the ambient temperature of the lamp. When a user controls turning on and brightness of the lamp using the keyboard 21, the controller 20 detects and receives a temperature value of the temperature sensor 10. The controller 20 compares the temperature value with the minimum output value according to a temperature compensation control program stored in the memory 24 and decides a minimum illumination intensity to generate a lamp control signal.

The lamp control signal of the controller 20 is transmitted to the decoder 30 set in the illuminating device through the communication line. The decoder 30 receives and decodes the lamp control signal and converts the decoded signal to a PWM or D/C control signal and outputs it to the ballast 40. The ballast 40 controls turning on and illumination intensity of the lamp 50 under the control of the controller 20.

The temperature compensation according to the present invention will now be explained.

Temperature compensation information stored in the memory 24 in response to a detected ambient temperature of the lamp and two illumination intensities set by the user using the keyboard 21 are compared to each other, and illumination data of higher one is output to the decoder 30.

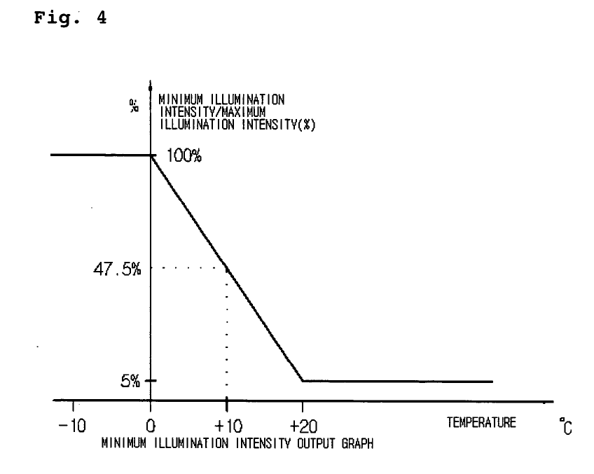

For example, when the detected ambient temperature is higher than 20° C., 5% of a maximum illumination intensity is output as a minimum illumination intensity. When the detected ambient temperature is lower than 0° C., 100% of the maximum illumination intensity is output as the minimum illumination intensity. That is, there is no dimming. In the case that the detected ambient temperature of the lamp is in the range of 0° C. to 20° C., a predetermined percent of the maximum illumination intensity, previously set depending on a temperature, is output as the minimum illumination intensity. FIG. 4 shows the minimum illumination intensity depending on a temperature.

Even when a user sets the minimum illumination intensity to a very low level, the lamp dimming control device of the present invention increases the minimum illumination intensity when the ambient temperature is lower than 20° C. This prevents the life span of the lamp from being reduced at a low temperature.

Even when the user operates the controller of the lamp dimming control device of the present invention to output 5% of the maximum illumination intensity as the minimum illumination intensity at 0° C., the controller 20 controls 100% of the maximum illumination intensity to be output as the minimum illumination intensity. Accordingly, the minimum illumination intensity in inverse proportion to the detected temperature is automatically output at temperatures lower than 20° C., as shown in FIG. 4.

If the user operates the controller to output 60% of the maximum illumination intensity as the minimum illumination intensity at 10° C., the controller controls 60% of the maximum illumination intensity to be output as the minimum illumination intensity. When the user operates the controller to output 45% of the maximum illumination intensity as the minimum illumination intensity at 10° C., the controller automatically controls 47.5% of the maximum illumination intensity to be output as the minimum illumination intensity.

According to the present invention, the temperature sensor 10 detects the ambient temperature of the lamp, and the controller 20 automatically compensates an output illumination intensity based on the detected temperature. The controller outputs 100% of the maximum illumination intensity as the output illumination intensity at 10° C. irrespective of an illumination intensity value set by a user. In addition, the controller controls the output illumination intensity in inverse proportion to the temperature to automatically dim the output illumination intensity to an illumination intensity set by the user at 0° C. to 20° C.

In another embodiment of the present invention, the decoder can control temperature compensation instead of the controller. For this, the temperature sensor is directly connected to the decoder.

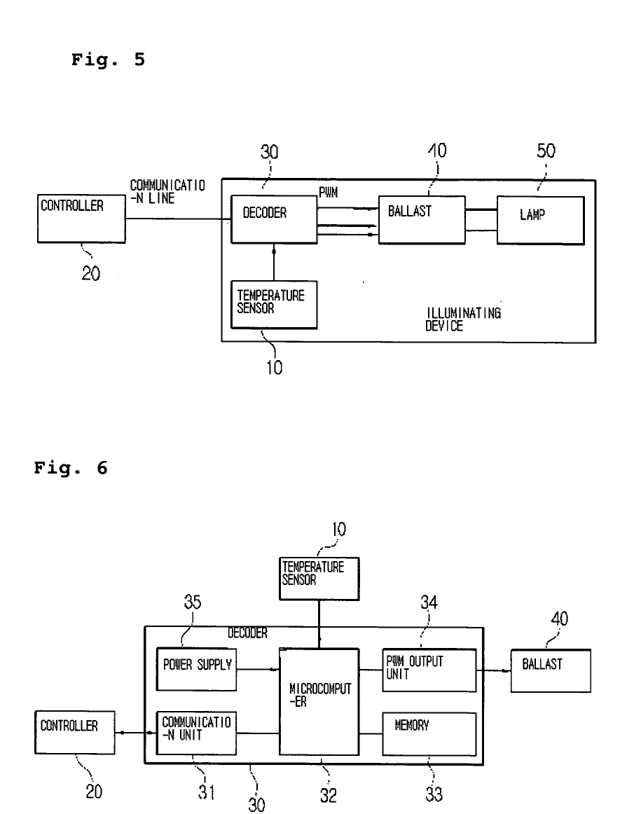

FIG. 5 is a block diagram of a lamp dimming control device using temperature compensation according to another embodiment of the present invention.

Referring to FIG. 5, the lamp dimming control device of the present invention includes a temperature sensor 10 for detecting the ambient temperature of a lamp 50, and a controller 20 by which a user controls turning on and brightness of the lamp 50 and which displays a state of the use of the lamp. The lamp dimming control device further includes a decoder 30 that is connected to the controller 20 through a communication line, decodes a control signal of the controller 20 to generate a signal for controlling turning on and brightness of the lamp 5 and controls the output power of the lamp with a minimum illumination intensity depending on the ambient temperature of the lamp detected by the temperature sensor 10, and a ballast 40 that turns on and controls the lamp 50 according to the lamp control signal of the decoder 30. Like reference numerals in FIGS. 1 and 5 denote like elements.

In another embodiment of the present invention, the decoder 30 carries out the temperature compensation based on a temperature detected by the temperature sensor 10 instead of the controller 20.

FIG. 6 is a block diagram of the decoder of the lamp control device using temperature compensation according to another embodiment of the present invention. Referring to FIG. 6, the decoder includes a communication unit 31 used for communication with the controller 20, a microcomputer 32 that decodes the lamp control signal of the controller 20 to output a lamp control signal and compares a temperature detection value of the temperature sensor 10 with a minimum output value to carry output temperature compensation with a minimum illumination intensity, a memory 33 for storing information required for decoding and control operations of the microcomputer 32, a PWM output unit 34 that outputs a lamp control output signal according to temperature compensation of the microcomputer 32 to the ballast 40 as a predetermined signal (for example, a PWM signal) that can be processed by the ballast 40, and a power supply 35 for providing an operation power to the decoder 30.

The decoder receives lamp control information from the controller 20 through the communication unit 31, decodes the lamp control information, stores state information of the lamp in the memory 33 or read the information from the memory 33, to generate the lamp control signal. The memory 33 stores current information of the lamp including information about a minimum illumination intensity depending on a temperature. The decoder generates a dimming signal as a PWM signal or a D/C signal corresponding to control information and a judgement based on the current temperature of the controller 20.

The temperature compensation is carried out in such a manner that a minimum illumination intensity of the lamp is controlled on the basis of a detected temperature, temperature compensation information stored in the memory, and a value designated by the controller. For example, 5% of the maximum illumination intensity is output as the minimum illumination intensity when the detected ambient temperature of the lamp is higher than 20° C. When the detected temperature is lower than 0° C., 100% of the maximum illumination intensity is output as the minimum illumination intensity. In this case, there is no dimming. When the detected temperature is in the range of 0° C. to 20° C., a predetermined percent of the maximum illumination intensity depending on a temperature is output as the minimum illumination intensity, as shown in FIG. 4.

Even when the controller 20 designates a low minimum illumination intensity, the minimum illumination intensity is increased, as shown in FIG. 4, on the basis of the ambient temperature of the decoder (ambient temperature of the lamp). Thus, it is possible to prevent the life span of the lamp from being reduced at a low temperature.

In the present invention, the lamp dimming control is carried out by the controller or the decoder. When the temperature sensor is connected to the controller, the lamp dimming control device can control heating/cooling as well as lamp dimming.

As described above, the present invention detects the ambient temperature of a lamp to output the minimum illumination intensity depending on the detected temperature. This extends the life span of the lamp. Furthermore, the present invention can install a control program using a temperature sensor in one of a controller and a decoder.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A lamp dimming control device wherein a controller generates a control signal depending on brightness controlled by a user and a ballast controls dimming of a lamp in response to the control signal, to thereby control turning on and brightness of the lamp, comprises:
a temperature sensor for sensing the ambient temperature of the lamp;
a controller for detecting a temperature value of the temperature sensor, comparing the detected temperature value with a minimum power value depending on a temperature, previously set by a program, to decide a minimum illumination intensity, and outputting a dimming control signal with the minimum illumination intensity;
a decoder connected with the controller through a communication line, installed in an illuminating device including the lamp, for decoding the output value of the controller to output a signal for controlling the lamp; and
a ballast for controlling turning on and brightness of the lamp in response to the output signal of the decoder.

2. The lamp dimming control device as claimed in claim 1, wherein the controller comprises:
a keyboard by which the user inputs signals for controlling turning on/off and brightness of the lamp;
a display unit for displaying a user's input state and an operation state using an LED;
a microcomputer for receiving the signals from the temperature sensor and the keyboard to control the display unit and controlling turning on and brightness of the lamp according to temperature compensation;
a memory for storing a program for a control operation of the microcomputer and data about the minimum illumination intensity depending on a temperature;
a communication unit for outputting the lamp control signal according to the control of the microcomputer to the decoder through a communication line; and
a power supply for supplying an operation power to the controller.

3. The lamp dimming control device as claimed in claim 2, wherein the controller controls lamp dimming on the basis of a brightness control value input by the user and a detected temperature, in such a manner that outputs 5% of a maximum illumination intensity as a minimum illumination intensity when the detected ambient temperature of the lamp is higher than 20° C., outputs 100% of the maximum illumination intensity as the minimum illumination intensity when the detected ambient temperature is lower than 0° C., and outputs a predetermined percent of the maximum illumination intensity, which is previously set depending on a temperature, as the minimum illumination intensity when the detected ambient temperature is in the range of 0° C. to 20° C.

4. A lamp dimming control device wherein a controller generates a control signal depending on brightness controlled by a user and a ballast controls dimming of a lamp in response to the control signal, to thereby control turning on and brightness of the lamp, comprises:
a temperature sensor for sensing the ambient temperature of the lamp;
a controller by which the user controls turning on and brightness of the lamp, the controller displaying a state of the use of the lamp;
a decoder connected with the controller through a communication line, for decoding the control signal of the controller to generate a signal for controlling turning on and brightness of the lamp, and controls the output power of the lamp with a minimum illumination intensity depending on the ambient temperature of the lamp sensed by the temperature sensor; and
a ballast that turns on and controls the lamp using the lamp control signal of the decoder.

5. The lamp dimming control device as claimed in claim 4, wherein the decoder controls lamp dimming on the basis of a brightness control signal of the controller in response to a brightness control value input by the user and a detected temperature, in such a manner that the decoder outputs 5% of a maximum illumination intensity as a minimum illumination intensity when the detected ambient temperature of the lamp is higher than 20°, outputs 100% of the maximum illumination intensity as the minimum illumination intensity when the detected ambient temperature is lower than 0° C., and outputs a predetermined percent of the maximum illumination intensity, which is previously set depending on a temperature, as the minimum illumination intensity when the detected ambient temperature is in the range of 0° C. to 20° C.
